(19) United States
(12) Patent Application Publication
(10) Pub. No.: US 2008/0306649 A1
(43) Pub. Date: Dec. 11, 2008

(54) Vehicle Driving Safety Control Apparatus

(76) Inventors: Jong-Soon Im, Seoul (KR); Han-Soo Yun, Seoul (KR); Jin-Yong Kim, Incheon (KR); Ji-Hun Park, Seoul (KR); Jun-Su Lim, Gyeonggi-do (KR); Myong-Ho Kim, Gyeongsangnam-do (KR)

Correspondence Address: MICHAEL BEST & FRIEDRICH LLP, 100 E WISCONSIN AVENUE, Suite 3300, MILWAUKEE, WI, 53202, US

(21) Appl. No.: 11/911,944

(22) PCT Filed: Apr. 18, 2006
(86) PCT No.: PCT/KR2006/001426

§ 371 Date: May 2, 2008

(30) Foreign Application Priority Data
Apr. 18, 2005 (KR) 10-2005-0031891

(51) Int. Cl. B60G 17/015; B60Q 1/00

(52) U.S. Cl. 701/30; 701/37; 701/29; 340/438

(57) ABSTRACT

A driving safety control apparatus for a vehicle is provided. In some embodiments, the driving safety control apparatus makes use of a hybrid wheel sensor capable of automatically detecting an abnormal state of one or more chassis components generated when the vehicle is running by using speed and acceleration signals of the hybrid wheel sensor with a semiconductor acceleration sensor mounted on the wheel of the vehicle, thereby informing the driver of the detected abnormal state. In this manner, the detected abnormal part can be repaired at an early stage. Also, the behavior of the vehicle wheels can be monitored, whereby signals representative of the measured behavior can be transmitted to an active suspension for improved control of the active suspension, compared to known systems.

### TECHNICAL FIELD

The present invention relates to a apparatus of driving safety control for automobile using a hybrid wheel sensor, capable of automatically detecting an abnormal state of chassis components generated when the vehicle is running by use of speed and acceleration signals of the hybrid wheel sensor with a semiconductor acceleration sensor mounted on wheels of the vehicle, informing a driver of the detected abnormal state, and repairing the abnormal part in its early stage, and simultaneously accurately measuring a behavior situation of the wheels, transmitting the measured behavior situation to an active suspension, and controlling the active suspension in a more improved way, compared to the known inventions.

### BACKGROUND ART

In general, the vehicle has various chassis components such as wheels, brake disks, brake pads, hub bearing units, driving shafts, steering knuckles, springs and shock absorbers, links, joints, and frames.

FIG. 1 is a schematic perspective view illustrating chassis components of an ordinary vehicle.

Referring to FIG. 1, the chassis components comprises a driving shaft 1 transmitting generation power of an engine to a driven shaft and simultaneously adjusting a vibration and noise or steerability of the vehicle; a hub bearing unit 3 coupled with a tire 2 therearound, driven by the power of the driving shaft 1 and supporting up-and-down and front-and-rear directional loads, and vertical and horizontal loads generated during cornering; a steering knuckle 4 acting as a joint between the driving shaft 1 and the hub bearing unit 3; and a shock absorber 6 supported on the steering knuckle 4 and having a spring 5 fitted therearound to perform damping action of a frame.

Although not illustrated, the chassis components includes break disk and pad for stopping or decelerating the vehicle, a linkage for improving stability when the vehicle performs cornering, and a frame for supporting a driving system and a body.

A wheel speed sensor is designed to sense a revolution per minute of an axle to transmit a sensed signal to an anti-lock brake system (ABS) controller, thereby minimizing abrasion of the brake pad when sudden stopping or starting, and adjusting a speed of each wheel so as to allow the vehicle to stably travel. The wheel speed sensor has been assembled and mounted to the driving shaft in former times, but to the hub bearing unit in recent times because the hub bearing unit has better assemblability and protectablity against foreign materials compared to the driving shaft.

FIG. 2 schematically illustrates a structure of a conventional wheel speed sensor of a vehicle.

Referring to FIG. 2, a conventional wheel sensor 20 of the vehicle is provided with circuit elements 22 on a board 21, on one side of which a wheel speed sensor 23 is provided.

FIG. 3 schematically illustrates a structure of a conventional hub bearing unit of a vehicle. The hub bearing unit comprises a hub 24, an outer annular flange 25 installed on one side of the hub, and a wheel speed sensor 26 sensing a wheel speed.

Each of the chassis components of the vehicle performs an important function, and has great influence on ride comfort and stability during running when damaged or mal-functioned. Hence, when a fault of the component is generated, a self-diagnosis function adapted to inform a driver of the fault to take a step in advance should be provided.

However, the conventional vehicle is not provided with a self-diagnosis system capable of informing the driver of an abnormal driving state caused by damages of driving relevant components such as the hub bearing unit, the shock absorber, the driving shaft, the steering knuckle, the linkage and so on. For this reason, the driver has no alternative but to intuitively determine an abnormal state of steerability through the sense of hearing or vibration of the chassis. This intuitive determination is very inaccurate because an error is greatly dependent on a skilled degree. As a result, it is impossible to accurately detect the abnormal state.

The apparatus of driving safety control for automobile having the self-diagnosis function is disclosed in U.S. Pat. No. 6,695,483, titled Sensor and Rolling Bearing Apparatus with Sensor. According to the 483 patent, a sensor and hub bearing unit has the self-diagnosis function capable of mounting therein a built-in acceleration sensor to check the damage and fault of a bearing. However, an apparatus and method for processing acceleration of a driving system to detect abnormal vibration of chassis components are not disclosed.

In this manner, when the chassis components are damaged or out of order, this is fatal to safety of the driver. However, a sensor or a system for diagnosing and checking such a damage or fault is not developed.

Meanwhile, an active suspension system is for making it possible to adjust the damping quantity of an existing shock absorber, thereby adjusting magnitude of the shock absorber according to up-and-down acceleration, a steering wheel speed, etc. of the vehicle to enable the driver to stably perform the cornering and traveling of the vehicle.

FIG. 4 illustrates a construction of a conventional active suspension system.

Referring to FIG. 4, the conventional active suspension system measures only the state of a chassis using a wheel speed sensor 31, a vehicle speed sensor 32, a steering wheel angular velocity sensor 33, a throttle position sensor 34, and a gravity sensor 35, and thereby adjusts a shock absorber 37 through a controller 36. However, because the acceleration characteristic of a driving system is not sufficiently transmitted, effective damping adjustment is not carried out.

### DISCLOSURE OF INVENTION

### Technical Problem

It is an objective of the present invention to provide a apparatus of driving safety control for automobile capable of improving stability by additionally attaching a semi-conductor acceleration sensor to a wheel speed sensor located at a hub bearing, receiving data from these sensor, comparing the received data with reference data stored in a memory, outputting a control signal of a damper actuator or a pneumatic active suspension system through an active suspension controller or transmitting an abnormal signal of a component generating abnormal vibration to a driver through a display unit via a self-diagnosis controller.

### Advantageous Effects

According to the present invention as described above, an effective active suspension system can be realized by installing the semiconductor acceleration sensor to the driving system, particularly the hub bearing unit, and receiving and analyzing a signal from each sensor. When any chassis component is damaged or defective, this situation is informed to the driver in advance. Thereby, it is possible to primarily prevent the damage of the component from being increased, and check a proper time to exchange the components in advance. As a result, a possibility of mass personal injury is prevented in advance, and thus safety of the user is maximized.

### BRIEF DESCRIPTION OF THE DRAWINGS

FIG. 1 is a schematic perspective view illustrating chassis components of an ordinary vehicle;

FIG. 2 schematically illustrates a structure of a conventional wheel speed sensor of a vehicle;

FIG. 3 schematically illustrates a structure of a conventional hub bearing unit of a vehicle;

FIG. 4 illustrates a construction of a conventional active suspension system;

FIG. 5 schematically illustrates a structure of a hybrid wheel sensor of a vehicle, according to an embodiment of the present invention;

FIG. 6 is a block diagram illustrating a apparatus of driving safety control for automobile according to an embodiment of the present invention;

FIG. 7 is a block diagram illustrating a apparatus of driving safety control for automobile according to another embodiment of the present invention; and

FIG. 8 is a block diagram illustrating another example of the apparatus of driving safety control for automobile of FIG. 7.

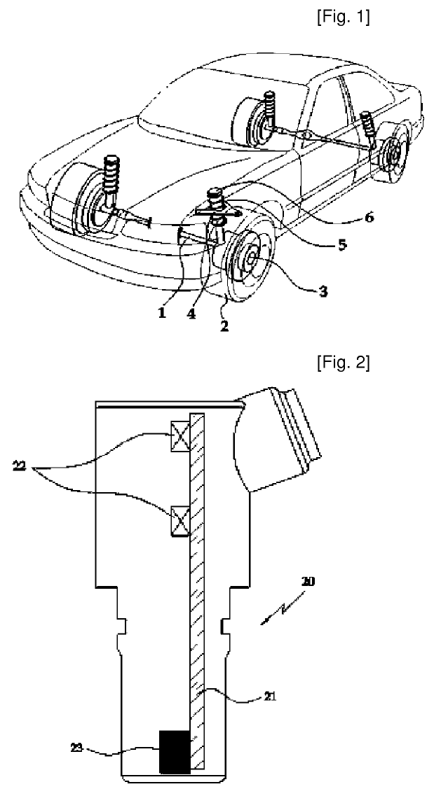

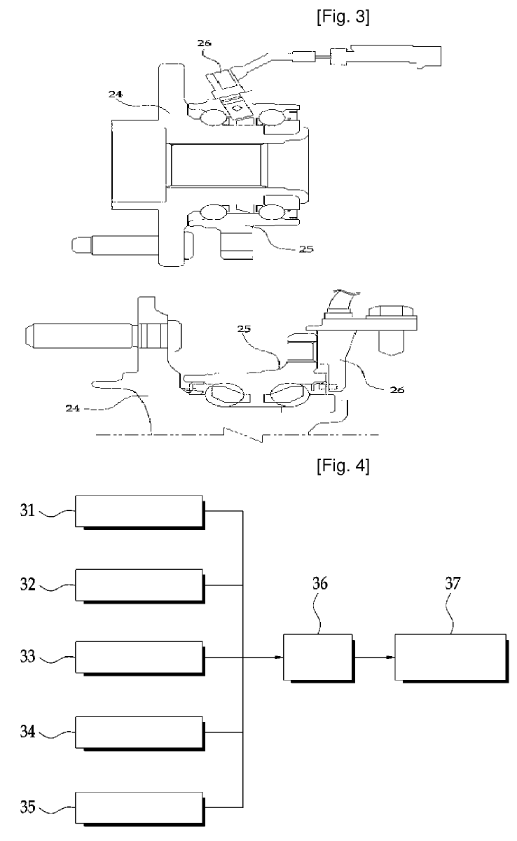

### EXPLANATION ON ESSENTIAL ELEMENTS OF DRAWINGS

40: acceleration sensor module 41, 51: board
42, 52: circuit elements 43: acceleration sensor
50: wheel speed sensor module 100: detector unit
110: vehicle height sensor
120: steering wheel angular velocity sensor
130: throttle position sensor 140: gravity sensor
150: hybrid wheel sensor 160: wheel speed sensor
170: semiconductor acceleration sensor
200: controller unit 210: first input/output
220: controller 230: memory
240: second input/output 300: drive unit
400: display unit 410: warning lamp
420: alarm 430: LCD
500 telematics system
600: service center 700: driver

### BEST MODE FOR CARRYING OUT THE INVENTION

To accomplish the objective of the present invention, the present invention has the following features.

According to an aspect of the present invention, there is provided a apparatus of driving safety control for automobile for a suspension of a vehicle having a wheel speed sensor, a vehicle height sensor, a gravity sensor, a hub bearing unit, and an actuator. The apparatus of driving safety control for automobile comprises: a detector unit installing a hybrid wheel sensor having a semiconductor acceleration sensor and the wheel speed sensor to the hub bearing unit, and detecting speed and acceleration of a hub bearing; a controller unit comparing vehicle state data detected by the detector unit with previously input reference data, and outputting a suspension control signal; and a drive unit driven based on the control signal output by the controller unit.

According to another aspect of the present invention, there is provided a apparatus of driving safety control for automobile for a fault self-diagnosis apparatus of a vehicle having a wheel speed sensor, a steering wheel angular velocity sensor, and a hub bearing unit. The apparatus of driving safety control for automobile comprises: a detector unit installing a hybrid wheel sensor having a semiconductor acceleration sensor and the wheel speed sensor to the hub bearing unit, and detecting speed and acceleration of a hub bearing; a controller unit comparing each data detected by the detector unit with previously input reference data, determining an abnormal driving state of the vehicle through a determination algorithm, and outputting a predetermined control signal when the abnormal driving state is determined; and a display unit displaying an abnormal state based on the control signal output by the controller unit.

According to the aspects of the present invention, the semiconductor acceleration sensor may be any one selected from a 1-axis sensor, a 2-axis sensor, and a 3-axis sensor.

The present invention having the foregoing features will be described in more detail through its exemplary embodiments.

### MODE FOR THE INVENTION

Hereinafter, exemplary embodiments of the present invention will be described with reference to the accompanying drawings.

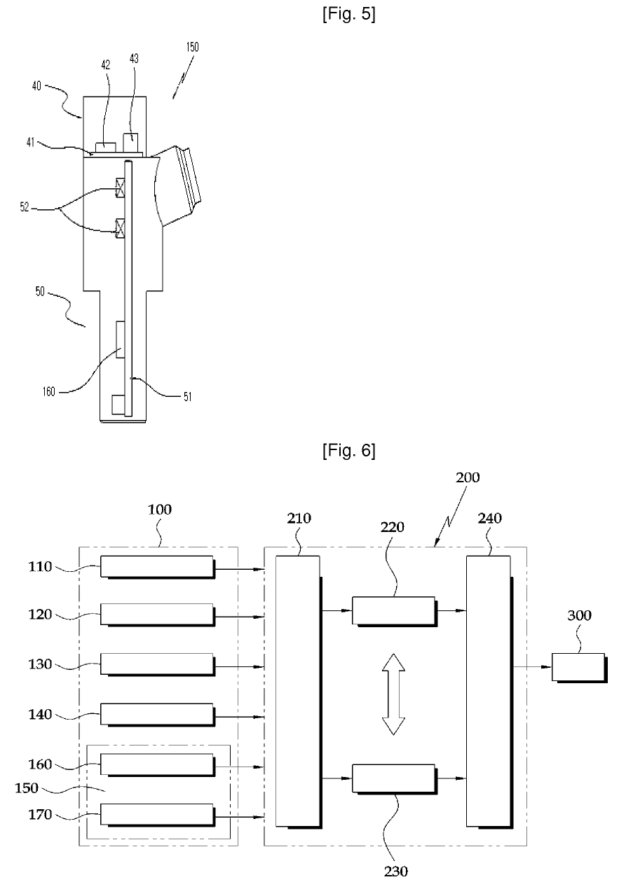

FIG. 5 schematically illustrates a structure of a hybrid wheel sensor of a vehicle, according to an embodiment of the present invention.

As illustrated in FIG. 5, the hybrid wheel sensor 150 of the vehicle comprises circuit elements 42 on a board 41, on one side of which an acceleration sensor 43 for sensing wheel speed, and a semiconductor acceleration sensor for measuring the acceleration of a hub bearing are provided.

A wheel speed sensor module 50 is designed to mount circuit elements 52 on a board 51, on one side of which a wheel speed sensor 160 is provided.

At this time, the wheel speed sensor module 50 is a structure installed to be opposite to a rotor, a rotating body, rotating in cooperation with the wheels of the vehicle, and acts to force a motor to rotate in a magnetic field of constant intensity generated from a magnet housed in the wheel speed sensor 160, generate induced voltage across a coil by variation in resistance of the magnetic field, output a square wave proportional to the wheel speed by the generation of the induced voltage, and sense the wheel speed.

Further, an acceleration sensor module 40 is designed to mount the circuit elements 42 on the board 41, on one side of which the acceleration sensor 43 is provided.

At this time, the acceleration sensor module 40 is attached to a frame over each wheel of the vehicle. The acceleration sensor module 40 measures acceleration and vibration of a driving system to extract a signal caused by a bounce motion of the driving system, and simultaneously extracts the vibration of the driving system, thereby utilizing it to diagnose an abnormal component. Thus, the acceleration sensor module 40 converts the acceleration and vibration of the bounce frame motion of the driving system into a gravitational acceleration, turns the gravitational acceleration in terms into an electric signal, a volt, and outputs the result.

FIG. 6 is a block diagram illustrating a apparatus of driving safety control for automobile according to an embodiment of the present invention.

Referring to FIG. 6, the apparatus of driving safety control for automobile having a hybrid wheel sensor according to an embodiment of the present invention comprises a detector unit 100, a controller unit 200, and a drive unit 300.

The detector unit 100 is provided with a vehicle height sensor 110, a steering wheel angular velocity sensor 120, a throttle position sensor 130, a gravity sensor 140, and a hybrid wheel sensor 150, and detects displacement data when the vehicle is running. The hybrid wheel sensor 150 is composed of a wheel speed sensor 160 and a semi-conductor acceleration sensor 170.

Here, displacement data of the wheels when the vehicle is running can be detected using the wheel speed sensor 160 and the semiconductor acceleration sensor 170. Further, the displacement data when the vehicle is running can be detected by the semiconductor acceleration sensor 170. According to circumstances, the semi-conductor acceleration sensor 170 may be implemented as any one selected from a 1-axis sensor capable of measuring acceleration in the direction of only one of x, y, and z axes, a 2-axis sensor capable of measuring acceleration in the directions of two axes, and a 3-axis sensor capable of measuring acceleration in the directions of all three axes.

Meanwhile, the controller unit 200 comprises a first input/output 210, a controller 220, a memory 230, and a second input/output 240. The first input/output 210 receives the data detected by the detector unit 100, and outputs it to the controller 220. The memory 230 stores reference data to be compared with the data detected by the detector unit 100. The second input/output 240 receives the data output by the controller 220, and outputs it to the drive unit 300.

The controller 220 extracts the reference data stored previously in the memory 230, and compares the reference data stored in the memory 230 with the data that are input through the first input/output 210 and measured by the respective sensors, thereby determining a state of the vehicle. At this time, when it is determined through the compared data of the controller 220 that operation of a suspension is required, the controller 220 controls operation of the drive unit 300 through the second input/output 240.

The drive unit 300 corresponds to a suspension, i.e. an actuator, operated based on a signal transmitted through the second input/output 240.

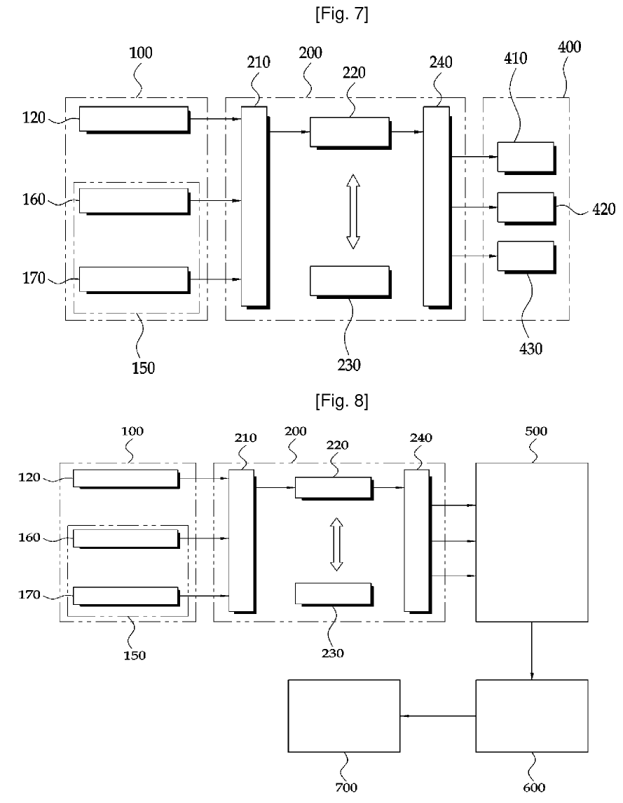

FIG. 7 is a block diagram illustrating a apparatus of driving safety control for automobile according to another embodiment of the present invention, and FIG. 8 is a block diagram illustrating another example of the apparatus of driving safety control for automobile of FIG. 7.

As illustrated in FIGS. 7 and 8, the apparatus of driving safety control for automobile having a hybrid wheel sensor according to another embodiment of the present invention comprises a detector unit 100, a controller unit 200, a drive unit 300, and a display unit 400.

The detector unit 100 is provided with a steering wheel angular velocity sensor 120, and a hybrid wheel sensor 150, and detects displacement data when the vehicle is running. The hybrid wheel sensor 150 is composed of a wheel speed sensor 160 and a semiconductor acceleration sensor 170.

Here, displacement data and vibration data of the wheels when the vehicle is running are detected using the wheel speed sensor 160 and the semiconductor acceleration sensor 170. The controller unit 200 analyzes these signals, and compares the displacement data and vibration data with existing data for a vibration characteristic of the chassis components, thereby detecting abnormal vibration of the chassis components around the wheels. Further, the displacement data when the vehicle is running can be detected by the semiconductor acceleration sensor 170. According to circumstances, the semiconductor acceleration sensor 170 may be implemented as any one selected from a 1-axis sensor capable of measuring acceleration in the direction of only one of x, y, and z axes, a 2-axis sensor capable of measuring acceleration in the directions of two axes, and a 3-axis sensor capable of measuring acceleration in the directions of all three axes.

Meanwhile, the controller unit 200 comprises a first input/output 210, a controller 220, a memory 230, and a second input/output 240. The first input/output 210 receives the data detected by the detector unit 100, and outputs it to the controller 220. The memory 230 stores reference data to be compared with the data detected by the detector unit 100. The second input/output 240 receives the data output by the controller 220, and outputs it to the display unit 400.

The controller 220 extracts the reference data stored previously in the memory 230, and compares the reference data stored in the memory 230 with the data that are input through the first input/output 210 and measured by the respective sensors, thereby determining an abnormal state of the chassis components. At this time, when it is determined from the result compared by the controller 220 that a driving state of the vehicle is abnormal, the controller 220 outputs a predetermined control signal to the display unit 400 through the second input/output 240.

The display unit 400 comprises a warning lamp 410 giving a visual warning based on the abnormal signal transmitted through the second input/output 240, an alarm 420 producing an alarm sound, and a liquid crystal display (LCD) 430 displaying the abnormal state of the chassis components in detail.

Further, the display unit 400 includes an active service system, which notifies the abnormal signal, abnormal information, transmitted through the second input/output 240 to an information center and a service center using a telematics terminal, and then to a driver via the service center.

An operation of the apparatus of driving safety control for automobile of the present invention will be described below in detail.

First, the first input/output 210 receives the data measured by each sensor of the detector unit 100, and outputs them to the controller unit 200.

The controller unit 200 extracts each reference data stored previously in the memory 230, and compares the extracted reference data with each data received through the first input/output 210, thereby determining an abnormal state of the chassis components of the vehicle.

The chassis components capable of making a self-diagnosis can enumerate the hub bearing unit, steering knuckle, brake disks, brake pads, shock absorbers, springs, links, joints, frames and so on.

As a result of determining the abnormal state of the chassis components of the vehicle, the abnormal state of the vehicle is output to the display unit 400 according to a control signal, and thereby an abnormal driving state of the vehicle is warned to the driver through the warning lamp 410, the alarm 420, and the LCD 430 of the display unit 400.

Further, the display unit 400 includes an active service system, which notifies an abnormal signal, abnormal information, transmitted through the second input/output 240 to an information center and a service center 600 using a telematics system 500, and then to a driver 700 via the service center 600.

The telematics system 500 refers to combination of multiple heterogeneous technologies, for instance, the vehicle and the computer, mobile telecommunication, and so on, and genetically refers to a series of apparatuses and their services, capable of improving safety and convenience of the driver 700 and the vehicle by exchanging information through a wired and wireless telecommunication network, and so on. The telematics system 500 is connected to a vehicle information network through a telematics terminal and monitor mounted to the vehicle, unlike a general personal digital assistant (PDA), and performs an information service for the driver 700.

1. A apparatus of driving safety control for automobile for a suspension of a vehicle having a wheel speed sensor, a vehicle height sensor, a gravity sensor, a hub bearing unit, and an actuator, the apparatus of driving safety control for automobile comprising:
a detector unit (100) installing a hybrid wheel sensor (150) having a semi-conductor acceleration sensor (170) and the wheel speed sensor (160) to the hub bearing unit, and detecting speed and acceleration of a hub bearing;
a controller unit (200) comparing vehicle state data detected by the detector unit (100) with previously input reference data, and outputting a suspension control signal; and
a drive unit (300) driven based on the control signal output by the controller unit (200).

2. A apparatus of driving safety control for automobile for a fault self-diagnosis apparatus of a vehicle having a wheel speed sensor, a steering wheel angular velocity sensor, and a hub bearing unit, the apparatus of driving safety control for automobile comprising:
a detector unit (100) installing a hybrid wheel sensor (150) having a semi-conductor acceleration sensor (170) and the wheel speed sensor (160) to the hub bearing unit, and detecting speed and acceleration of a hub bearing;
a controller unit (200) comparing each data detected by the detector unit (100) with previously input reference data, determining an abnormal driving state of the vehicle through a determination algorithm, and outputting a predetermined control signal when the abnormal driving state is determined; and
a display unit (400) displaying an abnormal state based on the control signal output by the controller unit.

3. The apparatus of driving safety control for automobile according to claim 2, wherein the display unit (400) comprises a warning lamp (410), an alarm (420), and a liquid crystal display (LCD) (430).

4. The apparatus of driving safety control for automobile according to claim 2, wherein the display unit (400) further comprises:
a telematics system (500) transmitting signal to a vehicle center; and
a service center (600) receiving a detection signal of each sensor via the vehicle center, analyzing the received signal, and notifying a driver (700) of information on maintenance of the vehicle.

5. The apparatus of driving safety control for automobile according to claim 1 or 2, wherein the hybrid wheel sensor (150):
includes a circuit board (51) as a basic construction, and a wheel speed sensor module (50) mounting at least one circuit element (52) and the wheel speed sensor (160) on the circuit board (51); and
integrally forms an acceleration sensor module (40) on one side of the wheel speed sensor module (50) by means of molding.

6. The apparatus of driving safety control for automobile according to claim 1 or 2, wherein the semiconductor acceleration sensor is any one selected from a 1-axis sensor, a 2-axis sensor, and a 3-axis sensor.
